(19) United States
(12) Patent Application Publication
(10) Pub. No.: US 2022/0017752 A1
(43) Pub. Date: Jan. 20, 2022

(54) BITUMEN WHICH IS SOLID AT AMBIENT TEMPERATURE

(71) Applicant: TOTAL MARKETING SERVICES, Puteaux (FR)

(72) Inventors: Régis VINCENT, Grigny (FR); Romain COLLIAT, Ruy-Montceau (FR)

(73) Assignee: TOTAL MARKETING SERVICES, Puteaux (FR)

(21) Appl. No.: 17/413,821

(22) PCT Filed: Dec. 9, 2019
(86) PCT No.: PCT/EP2019/084259

§ 371 Date: Jun. 14, 2021

(30) Foreign Application Priority Data
Dec. 12, 2018 (FR) FR1872746

(51) Int. Cl. C08L 95/00; C08K 5/20; C08K 5/092; C08K 5/25; C09D 195/00

(52) U.S. Cl. CPC C08L 95/00; C08K 5/20; C08L 2555/60; C08K 5/25; C09D 195/00; C08K 5/092

(57) ABSTRACT

A bituminous composition including at least: bitumen, a compound of general formula R1-(COOH)z (I), a compound of general formula R2-(NH)nCONH—X—(NHCO)p(NH)n-R3 (II), and a compound of general formula Ar1-R-Ar2 (III), in particular in solid form and divided at ambient temperature; and a method for producing a bituminous composition as defined above and to the use thereof as asphalt binder and/or in various industrial applications.

### TECHNICAL FIELD

The present invention relates to a bituminous composition which is solid at ambient temperature, notably at elevated ambient temperature. This composition is advantageously packaged in divided form, notably in the form of binder blocks. The present invention also relates to a method for preparing this composition and also to the use thereof as road binder and/or in various industrial applications. The present invention lastly relates to a method for transporting and/or storing and/or handling this composition in solid and divided form at ambient temperature, notably at elevated ambient temperature.

### PRIOR ART

Bitumen or bituminous binder is the main hydrocarbon binder used in the fields of road construction and civil engineering. In order to be able to be used as binder in these different applications, the bitumen has to exhibit certain physicochemical and mechanical properties. It must notably be sufficiently hard and have a good consistency at the use temperatures to avoid, for example, the formation of ruts caused by traffic. Bitumen must also be elastic in order to resist deformations imposed by the traffic and/or temperature changes, these phenomena leading to cracking of the bituminous mixes and/or to stripping of the surface aggregates. Lastly, bitumen must be sufficiently fluid at application temperatures which are as low as possible in order to enable, for example, good coating of the aggregates and laying of the bituminous mix on the road. The use of a bituminous binder thus requires the combination of hardness, consistency and even also the elasticity of the bitumen at use temperatures with a low viscosity at the working and application temperatures.

As bitumen alone is generally not elastic enough, polymers, which may optionally be crosslinked, are added to the bitumen. These crosslinked polymers provide bituminous compositions with markedly improved elastic properties. However, the crosslinking of the polymers is irreversible: once the crosslinking has been carried out, it is not possible to return to the initial state that existed before the crosslinking reaction. Crosslinked bituminous compositions thus have good elastic properties, but exhibit a very high viscosity. One of the drawbacks associated with this high viscosity is the need to heat the crosslinked bitumen to a working and application temperature greater than that of a non-crosslinked bitumen, which increases the energy costs and requires the use of additional protective measures for operators.

Depending on the applications targeted, it is necessary to find a good compromise between the mechanical properties, including the elasticity, the hardness, the consistency, the fluidity and the viscosity, in particular the hot viscosity of the binder.

Another problem in the use of bitumen is associated with its transportation, handling and storage. Generally, bitumen is stored and transported hot, in bulk, in tanker trucks or by boats at high temperatures of about 120° C. to 180° C. However, the storage and transport of hot bitumen presents certain drawbacks. The transportation of hot bitumen in liquid form is considered dangerous and it is highly restricted from a regulatory point of view. This mode of transportation does not present particular difficulties when the transportation equipment and infrastructures are in good condition. If this is not the case, it can become problematic: if the tanker truck is not sufficiently thermally insulated, the viscosity of the bitumen may increase during an excessively long trip. The delivery distances for hot bitumen in its fluid form are therefore limited. Moreover, maintaining bitumen at high temperatures in the tanks or in tanker trucks consumes energy. In addition, maintaining bitumen at high temperatures for a long period of time can affect the properties of the bitumen and thus change the final performance qualities of the bituminous mix.

In order to overcome the problems of transporting and storing hot bitumen, packagings allowing the transportation and storage of bitumens at ambient temperature have been developed. This mode of transportation of bitumen in packaging at ambient temperature represents only a minimal fraction of the amounts transported worldwide, but it corresponds to very real needs for geographic regions which are difficult and expensive to access using conventional transportation means.

EP1917309 teaches the preparation of a bitumen base having certain characteristics of a blown bitumen by addition of a blowing additive of formula Ar₁—R—Ar₂. This document is not concerned with the problems associated with the transportation and/or storage of the compositions that it discloses.

Application WO 2008107551 describes a method for the reversible crosslinking of bituminous compositions, based on the use of organogelator additives. The thermoreversibly crosslinked bituminous compositions thus obtained are hard at the use temperatures and have a reduced viscosity at the application temperatures.

Application WO 2016/016320 describes bitumen blocks comprising a chemical additive. These blocks have a good creep resistance and do not stick together, allowing optimized transportation and/or storage and/or handling.

Application WO 2018/115729 discloses the preparation of binder, notably bituminous binder, in divided form, said binder comprising at least one acidic compound of formula R—(COOH)_{z} and at least one amide compound of formula R′—(NH)ₙCONH—(X)ₘ—(NHCO)ₚ(NH)ₙ—R″.

Bitumen in divided form as disclosed in this document allows the transportation and/or the storage and/or the handling of the bitumen at ambient temperature without the latter creeping, as well as the reduction of adhesion and agglomeration among the bitumen units.

None of these documents discloses compositions comprising the combination of more than two organogelator additives.

Continuing its work, the applicant has discovered, surprisingly, a novel bituminous composition which is solid at ambient temperature, is usable as road binder or as leaktight binder and which makes it possible to more effectively avoid and reduce the adhesion and agglomeration during transportation and/or storage and/or handling thereof, at elevated ambient temperature, over long periods, and the properties of which are preserved over time compared to the prior art bitumens in divided form.

More specifically, the applicant has demonstrated that this novel bituminous composition, packaged in divided form, notably in the form of blocks, makes it possible to more effectively resist creep under extreme transportation and/or storage and/or handling conditions, in particular under conditions of compression, notably due to storage, over very long periods.

### SUMMARY OF THE INVENTION

The invention relates first of all to a bituminous composition comprising at least:
a) bitumen,
b) a compound of general formula (I):

R₁—(COOH)_{z} (I)

in which R₁ represents a linear or branched hydrocarbon chain, comprising from 4 to 68 carbon atoms, and z is an integer ranging from 2 to 4,
c) a compound of general formula (II):

R₂—(NH)ₙCONH—X—(NHCO)ₚ(NH)ₙ—R₃ (II)

in which:
the R₂ and R₃ groups, which may be identical or different, represent a hydrocarbon chain comprising from 1 to 22 carbon atoms and optionally comprising heteroatoms such as N, O, S, and R₃ may be H,
the group X represents an optionally substituted hydrocarbon chain comprising from 1 to 22 carbon atoms and optionally comprising heteroatoms such as N, O, S,
n and p are integers having a value of 0 or 1 independently of one another,
d) a compound of general formula (III):

Ar1-R—Ar2 (III)

in which:
Ar1 and Ar2 represent, independently of one another, an aromatic group comprising from 6 to 20 carbon atoms chosen from a benzene ring or a system of fused aromatic rings, said aromatic group being substituted by at least one hydroxyl group and optionally by one or more C₁-C₂₀ alkyl groups, and
R represents an optionally substituted divalent hydrocarbon radical, the main chain of which comprises from 6 to 20 carbon atoms and at least one group chosen from amide, ester, hydrazide, urea, carbamate and anhydride functions.

Preferably, the compound of formula (I) is chosen from diacids of general formula (IA):

HOOC—C_{w}H_{2w}—COOH (IA)

with w an integer ranging from 4 to 22, preferably from 4 to 12.

Preferably, the compound of general formula (II) is chosen from compounds of general formula (IIA):

R₂—CONH—X—NHCO—R₃ (IIA)

in which R₂, R₃ and X are as defined above.

Preferably, the compound of general formula (III) is 2′,3-bis[(3-[3,5-di-tert-butyl-4-hydroxyphenyl]propionyl)]propionohydrazide.

Advantageously, the bituminous composition according to the invention comprises from 0.1% to 10% by mass of one or more compounds of formula (I), more preferentially from 0.5% to 6% by mass, more preferentially from 0.5% to 5% by mass, and even more preferentially from 0.5% to 2.5% by mass, relative to the total mass of the bituminous composition.

Advantageously, the bituminous composition according to the invention comprises from 0.1% to 10% by mass of one or more compounds of formula (II), more preferentially from 0.5% to 6% by mass, more preferentially from 0.5% to 5% by mass, and even more preferentially from 0.5% to 3.5% by mass, relative to the total mass of the bituminous composition.

Advantageously, the bituminous composition according to the invention comprises from 0.1% to 10% by mass of one or more compounds of formula (III), more preferentially from 0.5% to 6% by mass, more preferentially from 0.5% to 5% by mass, and even more preferentially from 0.5% to 3% by mass, relative to the total mass of the bituminous composition.

Preferably, the bituminous composition according to the invention is in solid and divided form at ambient temperature, preferably in the form of blocks.

The invention also relates to a method for preparing a bituminous composition as defined above and in detail below, said method comprising bringing the bitumen and the compounds of formulae (I), (II) and (III) into contact at a temperature ranging from 70° C. to 220° C., optionally followed by forming the bituminous composition obtained into divided form, preferably in the form of blocks.

The invention is also directed to a bituminous composition capable of being obtained by the method defined above and in detail below.

The invention further relates to the use of a bituminous composition as defined above and in detail below as road binder, preferably for the manufacture of bituminous mixes.

An additional subject of the invention is a method for manufacturing bituminous mixes comprising at least one road binder and aggregates or recycled bituminous mix aggregates, said road binder being in the form of a bituminous composition as defined above and in detail below, this method comprising at least the steps of:
heating the aggregates to a temperature ranging from 100° C. to 180° C., preferably from 120° C. to 180° C.,
mixing the aggregates with the road binder in a vessel such as a mixer or a drum mixer,
obtaining bituminous mixes.

Advantageously, the method for manufacturing bituminous mixes defined above and in detail below does not comprise a step of heating the road binder before it is mixed with the aggregates.

The invention is also directed to the use of a bituminous composition as defined above and in detail below for preparing a leaktight coating, a membrane or a seal coat.

The invention lastly relates to a method for transporting and/or storing and/or handling bitumen, said bitumen being transported and/or stored and/or handled at temperature in the form of a bituminous composition as defined above and in detail below, preferably in solid and divided form.

### DETAILED DESCRIPTION

The expression “essentially composed of”, followed by one or more characteristics, means that components or stages which do not significantly modify the properties and characteristics of the invention can be included in the method or the material of the invention, in addition to the components or stages explicitly listed.

The expression “between X and Y” includes the limits, unless explicitly mentioned otherwise. This expression therefore means that the target interval includes the values X, Y and all the values ranging from X to Y.

### Bituminous Composition According to the Invention

The present invention relates to a bituminous composition comprising at least:

a) bitumen,

b) a compound of general formula (I):

R₁—(COOH)_{z} (I)

in which R₁ represents a linear or branched, saturated or unsaturated, hydrocarbon chain comprising from 4 to 68 carbon atoms, and z is an integer ranging from 2 to 4,

c) a compound of general formula (II):

R₂—(NH)ₙCONH—X—(NHCO)ₚ(NH)ₙ—R₃ (II)

in which:
the R₂ and R₃ groups, which may be identical or different, represent a saturated or unsaturated, linear, branched or cyclic, hydrocarbon chain comprising from 1 to 22 carbon atoms and optionally comprising heteroatoms such as N, O, S, C₅-C₂₄ hydrocarbon rings and/or C₄-C₂₄ hydrocarbon heterocycles comprising one or more heteroatoms such as N, O, S, and R₃ may be H,
the group X represents a saturated or unsaturated, linear, cyclic or branched, optionally substituted hydrocarbon chain comprising from 1 to 22 carbon atoms and optionally comprising heteroatoms such as N, O, S, C₅-C₂₄ hydrocarbon rings and/or C₄-C₂₄ hydrocarbon heterocycles comprising one or more heteroatoms such as N, O, S,
n and p are integers having a value of 0 or 1 independently of one another, and

d) a compound of general formula (III):

Ar1-R—Ar2 (III)

in which:
Ar1 and Ar2 represent, independently of one another, an aromatic group comprising from 6 to 20 carbon atoms and chosen from a benzene ring or a system of fused aromatic rings, said aromatic group being substituted by at least one hydroxyl group and optionally by one or more C₁-C₂₀ alkyl groups, and
R represents an optionally substituted divalent hydrocarbon radical, the main chain of which comprises from 6 to 20 carbon atoms and at least one group chosen from amide, ester, hydrazide, urea, carbamate and anhydride functions.

Preferably, the composition according to the invention essentially consists of:
a) bitumen,
b) one or more compounds of formula (I) as defined above and in detail below,
c) one or more compounds of formula (II) as defined above and in detail below,
d) one or more compounds of formula (III) as defined above and in detail below, and
e) optionally, one or more olefinic polymer adjuvants as defined below.

More preferentially, the composition according to the invention comprises, preferably essentially consists of:
a) from 70% to 99.7% by mass of bitumen,
b) from 0.1% to 10% by mass of one or more compounds of formula (I) as defined above and in detail below,
c) from 0.1% to 10% by mass of one or more compounds of formula (II) as defined above and in detail below,
d) from 0.1% to 10% by mass of one or more compounds of formula (III) as defined above and in detail below, and
e) optionally, from 0.05% to 15% by mass of one or more olefinic polymer adjuvants as defined below,
relative to the total mass of the bituminous composition according to the invention.

Advantageously, the composition according to the invention comprises, preferably essentially consists of:
a) from 82% to 98.5% by mass of bitumen,
b) from 0.5% to 6% by mass of one or more compounds of formula (I) as defined above and in detail below,
c) from 0.5% to 6% by mass of one or more compounds of formula (II) as defined above and in detail below,
d) from 0.5% to 6% by mass of one or more compounds of formula (III) as defined above and in detail below, and
e) optionally, from 0.1% to 10% by mass of one or more olefinic polymer adjuvants as defined below,
relative to the total mass of the bituminous composition according to the invention.

More advantageously, the composition according to the invention comprises, preferably essentially consists of:
a) from 85% to 98.5% by mass of bitumen,
b) from 0.5% to 5% by mass of one or more compounds of formula (I) as defined above and in detail below,
c) from 0.5% to 5% by mass of one or more compounds of formula (II) as defined above and in detail below,
d) from 0.5% to 5% by mass of one or more compounds of formula (III) as defined above and in detail below, and
e) optionally, from 0.5% to 6% by mass of one or more olefinic polymer adjuvants as defined below,
relative to the total mass of the bituminous composition according to the invention.

Even more advantageously, the composition according to the invention comprises, preferably essentially consists of:
a) from 91% to 98.5% by mass of bitumen,
b) from 0.5% to 2.5% by mass of one or more compounds of formula (I) as defined above and in detail below,
c) from 0.5% to 3.5% by mass of one or more compounds of formula (II) as defined above and in detail below,
d) from 0.5% to 3% by mass of one or more compounds of formula (III) as defined above and in detail below, and
e) optionally, from 0.5% to 6% by mass of one or more olefinic polymer adjuvants as defined below,
relative to the total mass of the bituminous composition according to the invention.

### Bitumen

The bituminous composition according to the invention can contain bitumens obtained from different origins. Among the bitumens that can be used according to the invention, mention may be made first of all of bitumens of natural origin, those contained in natural bitumen or natural asphalt deposits or bituminous sands and bitumens originating from the refining of crude oil. The bitumens according to the invention are advantageously chosen from bitumens originating from the refining of crude oil or obtained from bituminous sands. The bitumens may be chosen from bitumens or mixtures of bitumens originating from the refining of crude oil, in particular bitumens containing asphaltenes or pitch. The bitumens can be obtained by conventional methods for manufacturing bitumens in refining, in particular by direct distillation and/or vacuum distillation of oil. These bitumens can optionally be visbroken and/or deasphalted and/or air-rectified. It is common practice to perform vacuum distillation of the atmospheric residues originating from the atmospheric distillation of crude oil. This manufacturing process consequently corresponds to the sequence of an atmospheric distillation and a vacuum distillation, the feedstock feeding the vacuum distillation corresponding to the atmospheric distillation residues. These vacuum residues obtained from the vacuum distillation tower can also be used as bitumens. It is also common practice to inject air into a feedstock usually composed of distillates and heavy products originating from the vacuum distillation of atmospheric residues originating from the distillation of oil. This process makes it possible to obtain a blown or semi-blown or oxidized or air-rectified or partially air-rectified base. The different bitumens or bitumen bases obtained by the refining processes can be combined with one another in order to obtain the best technical compromise. The bitumen may also be a recycled bitumen. The bitumens may be bitumens of hard grade or of soft grade.

Advantageously, the bitumen is chosen from bitumens of natural origin; bitumens obtained from bituminous sands; bitumens obtained from the refining of crude oil, such as atmospheric distillation residues, vacuum distillation residues, visbroken residues, blown residues and mixtures thereof; and combinations of these or from synthetic bitumens, also referred to as clear binders.

In a particular embodiment according to the invention, the bitumen may also comprise at least one polymer and/or one flux.

As examples of polymers for bitumen, mention may be made of elastomers such as SB, SBS, SIS, SBS*, SBR, and EPDM copolymers, polychloroprene, polynorbornene and optionally polyolefins such as PE and PEHD polyethylenes, polypropylene PP, plastomers such as EVA and EMA, copolymers of olefins and of unsaturated carboxylic esters EBA, polyolefin elastomer copolymers, polybutene-type polyolefins, copolymers of ethylene and of esters of acrylic or methacrylic acid or maleic anhydride, ethylene-propylene copolymers, rubbers, polyisobutylenes, SEBS, and ABS.

Other additives may also be added to the bitumen according to the invention. These are for example vulcanizing agents and/or crosslinking agents capable of reacting with a polymer, when it is an elastomer and/or a plastomer, which may be functionalized and/or which may include reactive sites.

Among the vulcanizing agents, mention may be made of those based on sulfur and its derivatives, used to crosslink an elastomer at contents of from 0.01% to 30% by mass relative to the mass of elastomer.

Among the crosslinking agents, mention may be made of cationic crosslinking agents such as mono- or polyacids, or carboxylic anhydrides, carboxylic esters, sulfonic, sulfuric and phosphoric acids, or even acid chlorides, and phenols, at contents of from 0.01% to 30% by mass relative to the mass of polymer. These agents are capable of reacting with the functionalized plastomer and/or elastomer. They may be used in addition to or as a replacement for the vulcanizing agents.

Preferably, the bituminous composition according to the invention comprises from 70% to 99.7% by mass of bitumen, more preferentially from 82% to 98.5% by mass of bitumen, even more preferentially from 85% to 98.5% by mass of bitumen, and advantageously from 91% to 98.5% by mass of bitumen, relative to the total mass of the bituminous composition according to the invention.

### The Compound of Formula (I)

The bituminous composition according to the invention comprises first of all at least one compound of general formula (I):

R₁—(COOH)_{z} (I)

in which R₁ represents a linear or branched, saturated or unsaturated, hydrocarbon chain comprising from 4 to 68 carbon atoms, preferably from 4 to 54 carbon atoms, more preferentially from 4 to 36 carbon atoms, and z is an integer ranging from 2 to 4.

Preferably, the R₁ group is a saturated linear chain of formula C_{w}H_{2w}, with w being an integer ranging from 4 to 22, preferably from 4 to 12.

The compounds of formula (I) may notably be diacids (z=2), triacids (z=3) or tetraacids (z=4). Preferably, the compound of formula (I) is chosen from diacids with z=2. Preferably, the diacids have the general formula HOOC—C_{w}H_{2w}—COOH, with w being an integer ranging from 4 to 22, preferably from 4 to 12 and where z=2 and R₃ ═C_{w}H_{2w}.

Advantageously, the compound of formula (I) is chosen from adipic acid or 1,6-hexanedioic acid with w=4, pimelic acid or 1,7-heptanedioic acid with w=5, suberic acid or 1,8-octanedioic acid with w=6, azelaic acid or 1,9-nonanedioic acid with w=7, sebacic acid or 1,10-decanedioic acid with w=8, undecanedioic acid with w=9, 1,2-dodecanedioic acid with w=10 or tetradecanedioic acid with w=12. More advantageously, the compound of formula (I) is sebacic acid.

The diacids may also be diacid dimers of unsaturated fatty acid(s), i.e. dimers formed from at least one unsaturated fatty acid, for example from a single unsaturated fatty acid or from two different unsaturated fatty acids. The diacid dimers of unsaturated fatty acid(s) are conventionally obtained by intermolecular dimerization reaction of at least one unsaturated fatty acid (for example, Diels-Alder reaction). Preferably, a single type of unsaturated fatty acid is dimerized. They are derived in particular from the dimerization of an unsaturated, notably C₈ to C₃₄, notably C₁₂ to C₂₂, in particular C₁₆ to C₂₀, and more particularly C₁₈, fatty acid. A preferred fatty acid dimer is obtained by dimerization of linoleic acid, it being possible for this to be subsequently partially or totally hydrogenated. Another preferred fatty acid dimer has the formula HOOC—(CH₂)₇—CH═CH—(CH₂)₇—COOH. Another preferred fatty acid dimer is obtained by dimerization of methyl linoleate. In the same way, it is possible to have fatty acid triacids and fatty acid tetraacids, obtained respectively by trimerization and tetramerization of at least one fatty acid.

The content of compound(s) of formula (I) in the bituminous composition according to the invention ranges, preferably, from 0.1% to 10% by mass, more preferentially from 0.5% to 6% by mass, more preferentially from 0.5% to 5% by mass, and even more preferentially from 0.5% to 2.5% by mass, relative to the total mass of the bituminous composition according to the invention.

### The Compound of Formula (II)

The bituminous composition according to the invention also comprises at least one compound of general formula (II):

R₂—(NH)ₙCONH—X—(NHCO)ₚ(NH)ₙ—R₃ (II)

in which:
the R₂ and R₃ groups, which may be identical or different, represent a saturated or unsaturated, linear, branched or cyclic, hydrocarbon chain comprising from 1 to 22 carbon atoms and optionally comprising heteroatoms such as N, O, S, C₅-C₂₄ hydrocarbon rings and/or C₄-C₂₄ hydrocarbon heterocycles comprising one or more heteroatoms such as N, O, S, and R₃ may be H;
the group X represents a saturated or unsaturated, linear, cyclic or branched, optionally substituted hydrocarbon chain comprising from 1 to 22 carbon atoms and optionally comprising heteroatoms such as N, O, S, C₅-C₂₄ hydrocarbon rings and/or C₄-C₂₄ hydrocarbon heterocycles comprising one or more heteroatoms such as N, O, S;
n and p are integers having a value of 0 or 1 independently of one another,

Preferably, the R₂ and/or R₃ group comprises an aliphatic hydrocarbon chain having from 4 to 22 carbon atoms, notably chosen from C₄H₉, C₅H₁₁, C₉H₁₉, C₁₁H₂₃, C₁₂H₂₅, C₁₇H₃₅, C₁₈H₃₇, C₂₁H₄₃, and C₂₂H₄₅ groups.

Preferably, the X group represents a saturated, linear hydrocarbon chain comprising from 1 to 22 carbon atoms, advantageously from 1 to 12 carbon atoms and better still from 1 to 4 carbon atoms. More preferentially, the X group is chosen from C₂H₄ and C₃H₆ groups.

Preferably, the compound of general formula (II) is chosen from those satisfying the condition n=0.

Preferably, the compound of general formula (II) is chosen from those satisfying the following condition: the sum of the numbers of carbon atoms of R₂, X and R₃ is greater than or equal to 10, advantageously greater than or equal to 14, preferably greater than or equal to 18.

Preferably, the compound of general formula (II) is chosen from those satisfying the following condition: the number of carbon atoms of at least one of R₂ and R₃ is greater than or equal to 10, advantageously greater than or equal to 12, preferably greater than or equal to 14.

Preferably, the compound of general formula (II) is chosen from those of formula (IIA):

R₂—CONH—X—NHCO—R₃ (IIA)

in which R₂, R₃ and X are as defined above.

Preferably, in formula (IIA), the X group represents a saturated, linear hydrocarbon chain comprising from 1 to 22 carbon atoms, advantageously X represents a linear, saturated hydrocarbon chain comprising from 1 to 12 carbon atoms and better still from 1 to 4 carbon atoms. Preferably, the X group is chosen from C₂H₄ and C₃H₆ groups. More preferentially, the compound of general formula (IIA) is chosen from hydrazide derivatives such as the compounds C₅H₁₁—CONH—NHCO—C₅H₁₁, C₉H₁₉—CONH—NHCO—C₉H₁₉, C₁₁H₂₃—CONH—NHCO—C₁₁H₂₃, C₁₇H₃₅—CONH—NHCO—C₁₇H₃₅, or C₂₁H₄₃—CONH—NHCO—C₂₁H₄₃; diamides such as N,N′-ethylenedi(laurylamide) of formula C₁₁H₂₃—CONH—CH₂—CH₂—NHCO—C₁₁H₂₃, N,N′-ethylenedi(myristylamide) of formula C₁₃H₂₇—CONH—CH₂—CH₂—NHCO—C₁₃H₂₇, N,N′-ethylenedi(palmitamide) of formula C₁₅H₃₁—CONH—CH₂—CH₂—NHC₅—C₁₅H₃₁, N,N′-ethylenedi(stearamide) of formula C₁₇H₃₅—CONH—CH₂—CH₂—NHCO—C₁₇H₃₅; monoamides such as laurylamide of formula C₁₁H₂₃—CONH₂, myristylamide of formula C₁₃H₂₇—CONH₂, palmitamide of formula C₁₅H₃₁—CONH₂, stearamide of formula C₁₇H₃₅—CONH₂. Even more advantageously, the compound of general formula (IIA) is N,N′-ethylenedi(stearamide) of formula C₁₇H₃₅—CONH—CH₂—CH₂—NHCO—C₁₇H₃₅.

The content of compound(s) of formula (II) in the bituminous composition according to the invention ranges, preferably, from 0.1% to 10% by mass, more preferentially from 0.5% to 6% by mass, more preferentially from 0.5% to 5% by mass, and even more preferentially from 0.5% to 3.5% by mass, relative to the total mass of the bituminous composition according to the invention.

### The Compound of Formula (III)

The bituminous composition according to the invention lastly comprises at least one compound of general formula (III):

Ar1-R—Ar2 (III)

in which:
Ar1 and Ar2 represent, independently of one another, an aromatic group comprising from 6 to 20 carbon atoms and chosen from a benzene ring or a system of fused aromatic rings, said aromatic group being substituted by at least one hydroxyl group and optionally by one or more C₁-C₂₀ alkyl groups, and
R represents an optionally substituted divalent hydrocarbon radical, the main chain of which comprises from 6 to 20 carbon atoms and at least one group chosen from amide, ester, hydrazide, urea, carbamate and anhydride functions, preferably a hydrazide group.

Preferably, Ar1 and/or Ar2 are substituted by at least one alkyl group having 1 to 10 carbon atoms, advantageously in one or more ortho positions with respect to the hydroxyl group(s), more preferentially Ar1 and Ar2 are 3,5-dialkyl-4-hydroxyphenyl groups, advantageously 3,5-di-tert-butyl-4-hydroxyphenyl groups.

Preferably, R is in the para position with respect to a hydroxyl group of Ar1 and/or Ar2.

Advantageously, the compound of formula (III) is 2′,3-bis[(3-[3,5-di-tert-butyl-4-hydroxyphenyl]propionyl)]propionohydrazide.

The content of compound(s) of formula (III) in the bituminous composition according to the invention ranges, preferably, from 0.1% to 10% by mass, more preferentially from 0.5% to 6% by mass, more preferentially from 0.5% to 5% by mass, and even more preferentially from 0.5% to 3% by mass, relative to the total mass of the bituminous composition according to the invention.

### Optional Additives

According to one embodiment, the bituminous composition according to the invention may also comprise one or more optional additives, preferably chosen from olefinic polymer adjuvants.

The olefinic polymer adjuvant is preferably chosen from the group consisting of (a) ethylene/glycidyl (meth)acrylate copolymers; (b) ethylene/monomer A/monomer B terpolymers and (c) mixtures of these copolymers.

(a) The ethylene/glycidyl (meth)acrylate copolymers are advantageously chosen from, preferably random, copolymers of ethylene and of a monomer chosen from glycidyl acrylate and glycidyl methacrylate, comprising from 50% to 99.7% by mass, preferably from 60% to 95% by mass and more preferentially from 60% to 90% by mass of ethylene.

(b) The terpolymers are advantageously chosen from, preferably random, terpolymers of ethylene, of a monomer A and of a monomer B.

Monomer A is chosen from vinyl acetate and C₁ to C₆ alkyl acrylates or methacrylates, preferably chosen from C₁ to C₆, even more preferentially C₁-C₃, alkyl acrylates or methacrylates. Advantageously, the monomer A is chosen from ethyl acrylate and ethyl methacrylate. Even more advantageously, the monomer A is ethyl acrylate.

The monomer B is chosen from glycidyl acrylate and glycidyl methacrylate. Advantageously, the monomer B is glycidyl methacrylate.

The ethylene/monomer A/monomer B terpolymers comprise from 0.5% to 40% by mass, preferably from 5% to 35% by mass, more preferentially from 10% to 30% by mass, of units derived from the monomer A, and from 0.5% to 15% by mass, preferably from 2.5% to 15% by mass, of units derived from the monomer B, the remainder being formed by units derived from ethylene.

(c) The olefinic polymer adjuvant may be composed of a mixture of two or more copolymers chosen from the categories (a) and (b).

The olefinic polymer adjuvant is preferably chosen from the ethylene/monomer A/monomer B terpolymers (b) described above and from the mixtures (c) comprising them. The olefinic polymer adjuvant is advantageously chosen from the ethylene/monomer A/monomer B terpolymers (b) described above and from the mixtures (c) in which the terpolymers (b) represent at least 50% by mass relative to the total mass of the mixture, preferentially at least 75% by mass, better still at least 90% by mass. Advantageously, the olefinic polymer adjuvant is chosen from random terpolymers of ethylene, of a monomer A chosen from C₁ to C₆ alkyl acrylates or methacrylates and of a monomer B chosen from glycidyl acrylate and glycidyl methacrylate, comprising from 0.5% to 40% by mass, preferably from 5% to 35% by mass and more preferentially from 10% to 30% by mass of units derived from the monomer A and from 0.5% to 15% by mass and preferably from 2.5% to 15% by mass of units derived from the monomer B, the remainder being formed by units derived from ethylene.

Preferably, the number-average molecular mass (Mn) of the olefinic polymer adjuvant, determined by gel permeation chromatography with a polystyrene standard, ranges from 5000 to 50 000 g·mol⁻¹, more preferentially from 10 000 to 40 000 g·mol⁻¹, and even more preferentially from 25 000 to 40 000 g·mol⁻¹.

Preferably, the weight-average molecular mass (Mw) of the olefinic polymer adjuvant, determined by gel permeation chromatography with a polystyrene standard, ranges from 10 000 to 250 000 g·mol⁻¹, more preferentially from 50 000 to 200 000 g·mol⁻¹, and even more preferentially from 10 000 to 150 000 g·mol⁻¹.

Preferably, according to this embodiment, the bituminous composition according to the invention comprises from 0.05% to 15% by mass, preferably from 0.1% to 10% by mass, more preferentially from 0.5% to 6% by mass, of olefinic polymer adjuvant, relative to the total mass of the bituminous composition according to the invention.

### Method for Preparing a Bituminous Composition According to the Invention

The present invention also relates to a method for preparing a bituminous composition as defined above, this method comprising bringing, at a temperature ranging from 70° C. to 220° C., the compounds of formulae (I), (II) and (III), and optionally at least one olefinic polymer adjuvant as defined above, into contact with bitumen, optionally followed by a step of forming the bituminous composition, notably in divided form and preferably in the form of blocks.

The compounds of formulae (I), (II) and (III) may be brought into contact with the bitumen simultaneously, by direct addition of the compounds of formulae (I), (II) and (III) into the bitumen, or else by successive addition of the different compounds of formulae (I), (II) and (III). Preferably the compounds of formulae (I), (II) and (III) are brought into contact with the bitumen at a temperature ranging from 90° C. to 180° C., more preferentially ranging from 110° C. to 180° C.

The bitumen used in the method above may be used in pure or additivated form, notably additivated with a polymer; in anhydrous form or in the form of an emulsion; or else in combination with aggregates in the form of a bituminous mix.

Advantageously, the preparation method defined above comprises the following steps:

(A) introducing a bitumen into a container equipped with mixing means and heating the bitumen to a temperature ranging from 70° C. to 220° C., preferably ranging from 90° C. to 180° C., even more preferentially ranging from 110° C. to 180° C.,

(B) simultaneously or successively introducing the compounds of formulae (I), (II) and (III),

(C) optionally, introducing one or more olefinic polymer adjuvants,

(D) mixing the bituminous composition at a temperature ranging from 70° C. to 220° C., preferably ranging from 90° C. to 180° C., even more preferentially ranging from 110° C. to 180° C., preferably until a homogeneous composition is obtained, and

(E) optionally forming the bituminous composition resulting from step (D), notably in divided form, preferably in the form of blocks.

According to one particular embodiment, steps (B) and (C) defined above are performed simultaneously such that the compounds of formula (I), (II) and (III) and the olefinic polymer adjuvant(s) are introduced simultaneously into the heated bitumen.

According to one particular embodiment, step (E) of the method above is followed by a step (F) of coating the bituminous composition in divided form, notably in the form of blocks, over all or part of its surface with at least one anti-agglomerating agent. Step (F) of coating the bituminous composition in divided form, notably in the form of blocks, may be implemented by any known method. The coating may, for example, be implemented by dipping the units of bituminous composition obtained at the end of step (E) in a coating composition comprising one or more anti-agglomerating agents, followed by a drying step.

Composition which is in Solid and Divided Form at Ambient Temperature

According to one embodiment, the bituminous composition according to the invention is in solid and divided form at ambient temperature.

Preferably, according to this embodiment, the composition according to the invention also comprises at least one olefinic polymer adjuvant as defined above.

Advantageously, according to this embodiment, the bituminous composition according to the invention is in the form of blocks.

The term “block” is understood to mean a slab of the bituminous composition according to the invention having a mass ranging from 0.1 kg to 1000 kg, preferably ranging from 1 kg to 200 kg, more preferentially ranging from 1 kg to 50 kg, even more preferentially ranging from 5 kg to 35 kg, even more preferentially ranging from kg to 30 kg, said slab advantageously being parallelepipedal, preferably being cobblestone-shaped. The block according to the invention preferably has a volume of between 100 cm³ and 50 000 cm³, preferably between 5000 cm³ and 25 000 cm³ more preferentially between 10 000 cm³ and 30 000 cm³, even more preferentially between 14 000 cm³ and 25 000 cm³. When the block according to the invention is handled manually by one person, the mass of said block may vary from 1 to 20 kg, and from 20 to 50 kg in the case of handling by two people. When the handling is carried out by mechanical equipment, the mass of the block may vary from 50 to 1000 kg. The block according to the invention may be manufactured by any known method, for example according to the manufacturing method described in the document US2011/0290695.

According to one preferred embodiment, the bitumen blocks according to the invention are covered on at least a portion of their surface with an anti-agglomerating agent.

For the purposes of the invention, the term “anti-agglomerating agent” is understood to mean any compound which limits and/or reduces and/or inhibits and/or slows the agglomeration and/or adhesion between two units of bitumen in solid and divided form as defined below during the transportation and/or storage thereof at ambient temperature and which ensures the fluidity of same during the handling thereof.

Preferably, the anti-agglomerating agent is chosen from particulate anti-agglomerating agents and film-forming anti-agglomerating agents, and mixtures thereof, more preferentially from particulate anti-agglomerating agents and hot-melt anti-agglomerating agents.

### Particulate Anti-Agglomerating Agents

According to a first variant, the anti-agglomerating agent is chosen from particulate anti-agglomerating agents, preferably of mineral or organic origin, more preferentially of mineral origin.

For the purposes of the invention, the term “particulate anti-agglomerating agent” is understood to mean an anti-agglomerating agent which at ambient temperature is in the form of divided particles, notably in the form of chips, flakes or else powder.

Preferably, the particulate anti-agglomerating agent is chosen from: talc; fines generally with a diameter of less than 125 μm, such as siliceous fines, with the exception of calcium carbonate fines; sand, such as Fontainebleau sand; cement; carbon; wood residues such as lignin, lignosulfonate, conifer needle powders and conifer cone powders, notably of pine; rice husk ash; glass powder; clays such as kaolin, bentonite, vermiculite; alumina such as alumina hydrates; silica; silica derivatives such as silica fume, functionalized silica fume, notably hydrophobic or hydrophilic silica fume, fumed silicas, notably hydrophobic or hydrophilic fumed silicas, silicates, silicon hydroxides and silicon oxides; plastics powder; lime; hydrated lime; plaster; rubber crumb; polymer powder, using polymers such as styrene-butadiene copolymers (SB), styrene-butadiene-styrene copolymers (SBS); and mixtures of these materials.

Advantageously, the particulate anti-agglomerating agent is chosen from talc; fines generally with a diameter of less than 125 μm with the exception of calcium carbonate fines, such as siliceous fines; wood residues such as lignin, lignosulfonate, conifer needle powders and conifer cone powders, notably of pine; glass powder; sand, such as Fontainebleau sand; silica fume, notably hydrophobic or hydrophilic silica fume, fumed silicas, notably hydrophobic or hydrophilic fumed silicas; and mixtures thereof.

### Film-Forming Anti-Agglomerating Agents

According to a second variant, the anti-agglomerating agent is chosen from film-forming anti-agglomerating agents.

For the purposes of the invention, the term “film-forming agent”, is understood to mean a compound capable of forming a—preferably continuous—film, envelope or else a skin, on the surface of an object upon which it has been applied/deposited.

Preferably, the film-forming anti-agglomerating agent is chosen from hot-melt anti-agglomerating agents, gel-type anti-agglomerating agents, and mixtures thereof.

For the purposes of the invention, the term “hot-melt material” is understood to mean a material capable of softening under the effect of heat.

When the anti-agglomerating agent is chosen from hot-melt anti-agglomerating agents, it is, preferably, chosen from polypropylene, polyethylene and mixtures of polyethylene and polypropylene.

The bitumen blocks coated with a hot-melt anti-agglomerating agent have the advantage of being ready to use, that is to say that they may be heated directly in the melter or optionally introduced directly into the mixing unit for manufacturing bituminous road mixes, without being unwrapped beforehand. The hot-melt anti-agglomerating agent which melts with the bituminous core of the blocks according to the invention does not affect the properties of the bituminous composition.

For the purposes of the invention, the term “gel-type anti-agglomerating agent” is understood to mean a compound which makes it possible to increase the viscosity of a liquid or of a composition so as to form a gel film. Preferably, the gel-type anti-agglomerating agent has a dynamic viscosity of greater than or equal to 50 mPa·s, preferably of from 50 mPa·s to 550 mPa·s, more preferentially of from 80 mPa·s to 450 mPa·s, the viscosity being a Brookfield viscosity measured at 65° C. The viscosity of the gel-type anti-agglomerating agent is measured at 65° C. by means of a Brookfield CAP 2000+ viscometer at a rotational speed of 750 rpm. The measurement is read after 30 seconds for each temperature.

Preferably, the gel-type anti-agglomerating agent is chosen from:
cellulose derivatives, preferably cellulose ethers,
gelling compounds, preferably of plant or animal origin, such as: gelatin, agar-agar, alginates, starches, modified starches or gellan gums;
polyethylene glycols (PEGs) such as PEGs having a molecular weight of between 800 g·mol⁻¹ and 8000 g·mol⁻¹, for instance a PEG having a molecular weight of 800 g·mol⁻¹ (PEG-800), a PEG having a molecular weight of 1000 g·mol⁻¹ (PEG-1000), a PEG having a molecular weight of 1500 g·mol⁻¹ (PEG-1500), a PEG having a molecular weight of 4000 g·mol⁻¹ (PEG-4000) or a PEG having a molecular weight of 6000 g·mol⁻¹ (PEG-6000);
mixtures of such compounds.

More preferably, the gel-type anti-agglomerating agent is chosen from:
cellulose derivatives, preferably cellulose ethers,
gelling compounds, preferably of plant or animal origin, such as gelatin, agar-agar, alginates, and gellan gums;
polyethylene glycols (PEGs) such as PEGs having a molecular weight of between 800 g·mol⁻¹ and 8000 g·mol⁻¹, for instance a PEG having a molecular weight of 800 g·mol⁻¹ (PEG-800), a PEG having a molecular weight of 1000 g·mol⁻¹ (PEG-1000), a PEG having a molecular weight of 1500 g·mol⁻¹ (PEG-1500), a PEG having a molecular weight of 4000 g·mol⁻¹ (PEG-4000) or a PEG having a molecular weight of 6000 g·mol⁻¹ (PEG-6000);
mixtures of such compounds.

Advantageously, the gel-type anti-agglomerating agent is chosen from cellulose ethers.

Preferably, according to this embodiment, the anti-agglomerating agent(s) cover at least 50% of the surface of the bitumen blocks, preferably at least 60%, preferentially at least 70%, more preferentially at least 80%, and even more preferentially at least 90%.

Advantageously, the amount of anti-agglomerating agent(s) covering at least a portion of the surface of the bitumen blocks according to the invention is between 0.2% and 10% by mass, preferably between 0.5% and 8% by mass, more preferentially between 0.5% and 5% by mass, relative to the total mass of the bitumen blocks.

Preferably, the average thickness of the layer of anti-agglomerating agent(s) is greater than or equal to 20 μm, more preferentially ranges from 20 to 1 mm and more preferentially is of the order of 20 to 100 μm.

Advantageously, the anti-agglomerating agent is chosen from hot-melt materials and particulate anti-agglomerating agents as defined above, optionally in the form of mixtures. The block according to the invention is advantageously covered over all or part of its surface with one or more hot-melt materials forming a hot-melt film.

More advantageously, the block according to the invention is wrapped in a hot-melt film placed by any known method, preferably by a film made of polypropylene, polyethylene or a mixture of polyethylene and polypropylene. The bituminous composition packaged in bitumen blocks wrapped in a hot-melt film has the advantage of being ready to use, that is to say that it may be heated directly in the melter or optionally introduced directly into the mixing unit for manufacturing bituminous road mixes, without being unwrapped beforehand. The hot-melt film which melts with the bituminous composition according to the invention does not affect the properties thereof.

According to one embodiment, the block according to the invention may also be packaged in a cardboard packaging by any known method. In particular, the block according to the invention is packaged in a cardboard packaging by pouring the hot bituminous composition according to the invention into a cardboard packaging of which the wall of the inner face is silicone-based and then cooled, the dimensions of the cardboard packaging being suited to the desired weight and/or volume of the block according to the invention. When the block according to the invention is wrapped in a hot-melt film or is packaged in a cardboard packaging, the applicant has demonstrated that the deterioration of said hot-melt film or of said cardboard packaging during the transportation and/or storage at ambient and even elevated temperature of said block did not result in creeping of the block according to the invention. Consequently, the blocks according to the invention retain their initial shape and do not adhere to one another during the transportation and/or storage thereof at ambient temperature, despite the fact that the hot-melt film or the cardboard packaging may be damaged.

Without wishing to be bound by any theory, the applicant believes that the absence of creep of the bituminous composition which is solid at ambient temperature and in divided form, notably in the form of blocks, during the transportation and/or storage thereof at ambient, in particular elevated, temperature, is due to the formulation of the bituminous composition according to the invention and notably to the presence of the combination of the compounds of formulae (I), (II) and (III) defined above, alone or in a mixture within the bituminous composition.

Method for Transporting and/or Storing and/or Handling

The invention also relates to a method for transporting and/or storing and/or handling bitumen, said bitumen being transported and/or stored and/or handled at ambient temperature, notably at elevated ambient temperature, in the form of a bituminous composition according to the invention, preferably in solid and divided form, notably in the form of blocks.

Preferably, the bituminous composition according to the invention is transported and/or stored at an ambient temperature, notably at an elevated ambient temperature, for a duration of greater than or equal to 2 months, preferably greater than or equal to 3 months.

Ambient temperature is understood to mean the use temperature of the bitumen, it being understood that ambient temperature does not involve any provision of heat other than that resulting from the climatic conditions. Thus, the ambient temperature may reach high values, less than 100° C. during summer periods, in particular in geographical regions with a hot climate.

Preferably, the ambient temperature is less than 100° C. Advantageously, the ambient temperature is from 20° C. to 50° C., preferably from 25° C. to 50° C., preferably from 25° C. to 40° C. Advantageously, the elevated ambient temperature is from 40° C. to 90° C., preferably from 50° C. to 85° C., even more preferentially from 50° C. to 75° C., and even more preferentially from 50° C. to 70° C.

The bituminous compositions according to the present invention in solid, divided form at ambient temperature are notable for being easy to handle, even at elevated ambient temperatures. The bituminous compositions according to the present invention in solid and divided form at ambient temperature enable the transportation and/or the storage of the bituminous composition according to the invention under optimal conditions, in particular without the appearance of creep phenomena during the transportation and/or the storage thereof, even when the ambient temperature is elevated, and without degradation of the properties of said bituminous composition, indeed even with improvement thereof.

### Use of the Bituminous Compositions According to the Invention

Various uses of the bituminous compositions obtained according to the invention are envisaged, notably for the preparation of an anhydrous or emulsion-form bituminous binder, a polymeric bitumen, or a fluxed bitumen.

### Use as a Road Binder

The present invention relates to the use of a bituminous composition according to the invention, notably in solid and divided form at ambient temperature, as a road binder.

Preferably, the bituminous composition according to the invention is used, optionally in a mixture with aggregates or recycled bituminous mix aggregates, to manufacture a surface coating, a hot bituminous mix, a cold bituminous mix, a cold-poured bituminous mix, a grave emulsion, a base course, a binder course, a tack course or a surface course. These applications are targeted in particular at bituminous mixes as materials for the construction and the maintenance of road foundations and their surfacing, and also in carrying out all road works. Mention may be made of other combinations of the bituminous composition and of the aggregate having particular properties, such as anti-rutting layers, bituminous draining mixes or asphalts (mixture of a bituminous binder and sand-type aggregates).

The invention relates in particular to a method for manufacturing bituminous mixes comprising at least one road binder and aggregates or recycled bituminous mix aggregates, the road binder being in the form of a composition according to the invention, notably in solid and divided form at ambient temperature:

Preferably, the method for manufacturing bituminous mixes according to the invention comprises at least the steps of:
heating the aggregates to a temperature ranging from 100° C. to 180° C., preferably from 120° C. to 180° C.,
mixing the aggregates with the road binder notably in solid and divided form in a vessel such as a mixer or a drum mixer,
obtaining bituminous mixes.

In the case where the bituminous composition according to the invention is in solid and divided form, the method for manufacturing bituminous mixes according to the invention is advantageous in that it does not require a step of heating the bituminous composition according to the invention before mixing with the recycled bituminous mix aggregates or the aggregates since, on contact with the hot mixture of aggregates, the bituminous composition according to the invention which is solid at ambient temperature melts.

A further subject of the invention is a method for preparing a surface coating, a hot bituminous mix, a warm bituminous mix, a cold bituminous mix, a cold-poured bituminous mix, or a grave emulsion, said binder being combined with recycled milled products and/or aggregates, this method comprising at least the preparation of a bituminous composition according to the invention, notably in solid and divided form at ambient temperature.

### INDUSTRIAL APPLICATIONS

Another subject of the invention relates to the use of a bituminous composition according to the invention, notably in solid and divided form at ambient temperature, in various industrial applications, notably for preparing a leaktight coating, a membrane or a seal coat.

The bituminous compositions according to the invention are particularly suitable for the manufacture of leaktight membranes, of noise-reduction membranes, of insulating membranes, of surface coatings, of carpet tiles or of seal coats.

The invention lastly relates to a method for preparing a leaktight coating, a membrane or a seal coat, this method comprising at least the use of a bituminous composition according to the invention, notably in solid and divided form at ambient temperature.

The various embodiments, variants, preferences and advantages described above for each of the subjects of the invention apply to all the subjects of the invention and can be taken separately or in combination.

The invention is illustrated by the following examples, given without implied limitation.

### EXAMPLES

In these examples, the parts and percentages are expressed by weight, unless otherwise indicated.

### Materials and Methods

The rheological and mechanical characteristics of the bitumen and of the bituminous compositions to which reference is made in these examples are measured according to the methods indicated in table 1.

TABLE 1

| Property | Abbreviation | Unit | Measurement standard |
|---|---|---|---|
| Needle penetrability | P₂₅ | 1/10 mm | NF EN 1426 |
| at 25° C. | | | |
| Ring-and-ball | RBT | ° C. | NF EN 1427 |
| softening | | | |
| temperature | | | |
| Maximum force | Fₘₐₓ | N | See protocol below |

### The Bitumen Base:

A bitumen base of 35/50 grade, denoted B0, having a penetrability P25 of 44 1/10 mm and an RBT of 51.6° C. and commercially available from Total Marketing Services, is selected.

Additives:
Additive A1 of formula (I): sebacic acid,
Additive A2 of formula (II): N,N′-ethylenedi(stearamide) sold by Croda under the name Crodawax 140 ®, and
Additive A3 of formula (III): 2′,3-bis[(3-[3,5-di-tert-butyl-4-hydroxyphenyl]propionyl)]propionohydrazide (CAS 32687-78-8) sold by BASF under the brand Irganox MD 1024@.

### Method for Preparing the Bituminous Compositions

The bitumen base (B₀) is introduced into a reactor maintained at 160° C. with stirring at 300 revolutions/min for two hours. The various additives are then introduced into the reactor. The contents of the reactor are maintained at 160° C. with stirring at 300 revolutions/min for 1 hour.

### Method for Preparing a Bituminous Block

A mass of approximately 0.5 kg of the bituminous composition heated to 160° C. is poured into a rectangular steel mold covered with a hot-melt polyethylene film. The mold is then cooled to ambient temperature, and the block removed from the mold.

Protocol for measuring the maximum force (Fₘₐₓ)

This test is carried out in order to evaluate the compressive strength of a bituminous composition subjected to an imposed load at a constant speed and at a temperature of 50° C.

The maximum force (Fₘₐₓ) is measured using a texture analyzer sold under the name LF Plus by the company Lloyd Instruments and equipped with a thermal chamber. To do this, a cylindrical metallic box containing a 60 g mass of the bituminous composition to be analyzed is placed inside the thermal chamber regulated to a temperature of 50° C. The piston of the texture analyzer is a cylinder with a diameter equal to 25 mm and a height of 60 mm. The cylindrical piston is at the start placed in contact with the upper surface of the bituminous composition. It then moves vertically downward, at a constant speed of 1 mm/min, over a calibrated distance of 10 mm, so as to exert a compressive force on the upper surface of the bituminous composition. The texture analyzer measures the maximum compressive force applied by the piston on the bituminous composition at 50° C.

The measurement of the maximum compressive force enables an evaluation of the capacity of the bituminous composition to resist deformation. The greater the value for the maximum force, the better will be the deformation resistance of a bituminous block obtained from this bituminous composition.

### Results

### 1. Preparation of the Various Compositions

The compositions C₁ to C₈, corresponding to the mixtures detailed in table 2 below, are prepared according to the protocol described above.

Compositions C₁ to C₆ are comparative.

Compositions C₇ and C₈ are according to the invention.

TABLE 2

| | 1 additive | | | 2 additives | | | 3 additives | |
|---|---|---|---|---|---|---|---|---|
| | C₁ | C₂ | C₃ | C₄ | C₅ | C₆ | C₇ | C₈ |
| B₀ (%) | 98.5 | 97.5 | 99.25 | 96.0 | 95.3 | 95.3 | 96.2 | 96.0 |
| A₁ (%) | 1.5 | — | — | 1.5 | — | 4.0 | 1.2 | 1.5 |
| A₂ (%) | — | 2.5 | — | 2.5 | 4.0 | — | 2.0 | 1.6 |
| A₃ (%) | — | — | 0.75 | — | 0.7 | 0.7 | 0.6 | 1.9 |
| A₁ + A₂ + | 1.5 | 2.5 | 0.75 | 4 | 4.7 | 4.7 | 3.8 | 5 |
| A₃ (%) | | | | | | | | |

2. Rheological and Mechanical Properties of the Compositions C₁ to C₈

The mechanical and rheological properties of the compositions C₁ to C₈ prepared above were measured according to the protocols defined above.

The results of these measurements are given in table 3 below.

TABLE 3

| | B₀ | C₁ | C₂ | C₃ | C₄ | C₅ | C₆ | C₇ | C₈ |
|---|---|---|---|---|---|---|---|---|---|
| P₂₅ | 44 | 26 | 35 | 35 | 20 | 28 | 23 | 20 | 17 |
| (1/10 | | | | | | | | | |
| mm) | | | | | | | | | |
| RBT | 51.6 | 106.5 | 86.5 | 102.0 | 106.0 | 103.5 | 99.5 | 105.5 | 96.5 |
| (° C.) | | | | | | | | | |
| Fₘₐₓ | 0.9 | 23.6 | 2.98 | 75 | 83 | 78.9 | 85.7 | 192 | 310 |
| (N) | | | | | | | | | |

### Penetrability at 25° C. (P₂₅)

The compositions C₇ and C₈ according to the invention have reduced penetrability values compared to those of compositions C₁ to C₃ comprising a single additive A₁, A₂ or A₃.

The compositions C₇ and C₈ according to the invention additionally have similar or reduced penetrability values compared to those of compositions C₄ to C₆ comprising the combination of two additives A₁ and/or A₂ and/or A₃.

The bituminous compositions according to the invention therefore have a similar or reduced penetrability, compared to those of compositions comprising only one or two additives chosen from A₁, A₂ and A₃.

### Ring-and-Ball Softening Temperature (RBT)

The compositions C₁ to C₈ have a similar ring-and-ball softening temperature.

### Maximum Force (Fₘₐₓ)

Among the compositions C₁ to C₆, the highest value for maximum force is achieved by composition C₆, with 85.7 N.

Composition C₇ according to the invention exhibits a maximum force equal to 192 N, i.e. more than 2 times greater than that of composition C₆.

Composition C₈ according to the invention exhibits a maximum force equal to 310 N, i.e. more than 3.5 times greater than that of composition C₆.

The compositions according to the invention therefore exhibit a maximum force which is markedly greater than that of compositions C₁ to C₆.

The high maximum force of the compositions according to the invention is evidence of an improved deformation resistance of the compositions according to the invention compared to the prior art compositions C₁ to C₆.

Formed into blocks, the compositions C₇ and C₈ according to the invention are storage-stable and notably have an improved creep strength compared to the compositions C₁ to C₆.

1-15. (canceled)

16. A bituminous composition comprising at least:
a) bitumen,
b) a compound of general formula (I):
R₁—(COOH)_{z} (I)
in which R₁ represents a linear or branched hydrocarbon chain, comprising from 4 to 68 carbon atoms, and z is an integer ranging from 2 to 4,
c) a compound of general formula (II):
R₂—(NH)ₙCONH—X—(NHCO)ₚ(NH)ₙ—R₃ (II)
in which:
the R₂ and R₃ groups, which may be identical or different, represent a hydrocarbon chain comprising from 1 to 22 carbon atoms and optionally comprising heteroatoms, and R₃ may be H,
the group X represents an optionally substituted hydrocarbon chain comprising from 1 to 22 carbon atoms and optionally comprising heteroatoms,
n and p are integers having a value of 0 or 1 independently of one another,
d) a compound of general formula (III):
Ar1-R—Ar2 (III)
in which:
Ar1 and Ar2 represent, independently of one another, an aromatic group comprising from 6 to 20 carbon atoms chosen from a benzene ring or a system of fused aromatic rings, the aromatic group being substituted by at least one hydroxyl group and optionally by one or more C₁-C₂₀ alkyl groups, and
R represents an optionally substituted divalent hydrocarbon radical, the main chain of which comprises from 6 to 20 carbon atoms and at least one group chosen from amide, ester, hydrazide, urea, carbamate and anhydride functions.

17. The bituminous composition as claimed in claim 16, wherein the compound of formula (I) is chosen from diacids of general formula (IA):
HOOC—C_{w}H_{2w}—COOH (IA)
with w an integer ranging from 4 to 22.

18. The bituminous composition as claimed in claim 17, wherein the compound of formula (I) is sebacic acid.

19. The bituminous composition as claimed in claim 16, wherein the compound of general formula (II) is chosen from compounds of general formula (IIA):
R₂—CONH—X—NHCO—R₃ (IIA)
in which R₂, R₃ and X are as defined in claim 16.

20. The bituminous composition as claimed in claim 19, wherein the compound of general formula (IIA) is N,N′-ethylenedi(stearamide).

21. The bituminous composition as claimed in claim 16, in which the compound of general formula (III) is 2′,3-bis[(3-[3,5-di-tert-butyl-4-hydroxyphenyl]propionyl)]propionohydrazide.

22. The bituminous composition as claimed in claim 16, comprising from 0.1% to 10% by mass of one or more compounds of formula (I), relative to the total mass of the bituminous composition.

23. The bituminous composition as claimed in claim 16, comprising from 0.1% to 10% by mass of one or more compounds of formula (II), relative to the total mass of the bituminous composition.

24. The bituminous composition as claimed in claim 16, comprising from 0.1% to 10% by mass of one or more compounds of formula (III), relative to the total mass of the bituminous composition.

25. The bituminous composition as claimed in claim 16, comprising:
a) from 70% to 99.7% by mass of bitumen,
b) from 0.1% to 10% by mass of one or more compounds of formula (I),
c) from 0.1% to 10% by mass of one or more compounds of formula (II),
d) from 0.1% to 10% by mass of one or more compounds of formula (III), and
e) optionally, from 0.05% to 15% by mass of one or more olefinic polymer adjuvants, relative to the total mass of the bituminous composition.

26. The bituminous composition as claimed in claim 25, comprising
a) from 82% to 98.5% by mass of bitumen,
b) from 0.5% to 6% by mass of one or more compounds of formula (I),
c) from 0.5% to 6% by mass of one or more compounds of formula (II),
d) from 0.5% to 6% by mass of one or more compounds of formula (III), and
e) optionally, from 0.1% to 10% by mass of one or more olefinic polymer adjuvants,
relative to the total mass of the bituminous composition.

27. The bituminous composition as claimed in claim 16, in solid and divided form at ambient temperature.

28. The bituminous composition as claimed in claim 27, which is in the form of blocks.

29. A method for preparing a bituminous composition as claimed in claim 16, comprising bringing the bitumen and the compounds of formulae (I), (II) and (III) into contact at a temperature ranging from 70° C. to 220° C., optionally followed by forming the bituminous composition obtained into divided form.

30. The bituminous composition as claimed in claim 16 which is a road binder.

31. A method for manufacturing bituminous mixes comprising at least one road binder and aggregates or recycled bituminous mix aggregates, the road binder being in the form of a bituminous composition as claimed in claim 30, this method comprising at least the steps of:
heating the aggregates to a temperature ranging from 100° C. to 180° C.,
mixing the aggregates with the road binder in a vessel,
obtaining bituminous mixes.

32. The method as claimed in claim 31, which does not comprise a step of heating the road binder before it is mixed with the aggregates.

33. The bituminous composition as claimed in claim 16 which is a leaktight coating, a membrane or a seal coat.

34. A method for transporting and/or storing and/or handling bitumen, wherein the method comprises
a step consisting in the preparation of the bitumen in divided form according to claim 27, and a step wherein the bitumen is transported and/or stored and/or handled at ambient temperature.
